(19) United States
(12) Patent Application Publication
(10) Pub. No.: US 2006/0078275 A1
(43) Pub. Date: Apr. 13, 2006

(54) Display apparatus and method for displaying screen where dragging and dropping of object can be executed and program stored in computer-readable storage medium

(75) Inventor: Yasushi Oowa, Machida-shi (JP)

Correspondence Address: Canon U.S.A. Inc.,;Intellectual Property Division, 15975 Alton Parkway, Irvine, CA, 92618-3731, US

(73) Assignee: Canon Kabushiki Kaisha, Ohta-ku (JP)

(21) Appl. No.: 11/221,087

(22) Filed: Sep. 7, 2005

(30) Foreign Application Priority Data
Sep. 30, 2004 (JP) 2004-287650

(51) Int. Cl. H04N 5/76

(52) U.S. Cl. 386/46; 348/231.2

(57) ABSTRACT

A data storage apparatus is provided which includes a storage device for storing digital data. In response to writing of data input from an external apparatus into the storage device, the data storage apparatus analyzes the written data, and performs at least one process and/or algorithm on the written data according to the analysis performed by the control device.

### BACKGROUND OF THE INVENTION

1. Field of the Invention

The present invention relates to a data storage apparatus storing data output from a data processor such as a digital camera or a video camera-recorder (camcorder).

2. Description of the Related Art

Typically, a digital camera includes a storage medium, performs special algorithms and/or “special” processes on a photographed image, and writes the resulting image into the storage medium. The special processes include various image processes, such as compression using a predetermined compression technique, rotation, and rendering print data. Typically, an imaging device performs a photographing process and an image process in sequential turns (i.e., serially). The imaging device also performs a reproduction process and a printing process of photographed images in sequential turns. A system in which a digital camera and a printer are connected is disclosed in Japanese Patent Laid-Open No. 2004-070611.

However, if a desired special process is not supported by a digital camera, it is necessary to transfer data to a personal computer (PC) to perform the special process on the PC. Since a photographing process and an image process are performed in sequential order, processing latency increases, and the photographing interval also increases. Furthermore, since a reproduction process and a printing process of images are performed in sequential order, processing latency similarly increases, and it is difficult to display and print a reproduced image at the same time or it takes a longer time to display and print a reproduced image.

### SUMMARY OF THE INVENTION

The present invention provides a data storage apparatus and a data processing method that allows one or more algorithms and/or “special” processes, which are not supported by an imaging device, to be performed by a storage apparatus. The present invention further provides a data storage apparatus and a data processing method in which a camera and a storage apparatus share processes, such as a photographing process and an image process, and a reproduction process and a printing process, so that the processes can be performed in parallel to decrease processing latency.

An exemplary data storage apparatus may include a storage device adapted to store and read digital data, an external connection device adapted to communicate with an external apparatus, a control device adapted to respond to writing of data input from the external connection device into the storage device and adapted to analyze the written data, and a processing device adapted to perform a process on the written data according to the analysis performed by the control device.

Further features of the present invention will become apparent from the following description of exemplary embodiments with reference to the attached drawings.

### BRIEF DESCRIPTION OF THE DRAWINGS

FIG. 1 is a block diagram of a storage apparatus, according to an exemplary embodiment of the present invention.

FIG. 2 is a flowchart of an exemplary basic process performed in a storage apparatus, according to a first embodiment of the present invention.

FIG. 3 is a flowchart of an exemplary first specific process showing the file analysis in step S203 and the process request determination from step S204 from FIG. 2, according to an aspect of the present embodiment.

FIG. 4 is an exemplary management table which is adapted to manage the correspondence between extensions and image processes, according to an aspect of the present embodiment.

FIG. 5 is a flowchart of an exemplary second specific process showing the file analysis from step S203 and the process request determination in step S204 from FIG. 2, according to an aspect of the present embodiment.

FIG. 6 is a diagram of an exemplary text file including an image process command, according to an aspect of the present embodiment.

FIG. 7 is a flowchart of an exemplary third specific process showing the file analysis from step S203 and the process request determination from step S204 shown in FIG. 2, according to an aspect of the present embodiment.

FIG. 8 is a structure diagram of an exemplary file which includes an image process request, according to an aspect of the present embodiment.

FIG. 9 is a flowchart of an exemplary alternative basic process performed in a storage apparatus according to a second embodiment of the present invention.

FIG. 10 is a flowchart of another exemplary alternative basic process performed in a storage apparatus according to a third embodiment of the present invention.

FIG. 11 is an exemplary management table which is adapted to manage the correspondence between storage areas and image processes, according to an aspect of the present embodiment.

FIG. 12 is an exemplary memory map diagram of a DRAM, according to an aspect of the present embodiment.

FIG. 13 is a flowchart of still yet another exemplary alternative basic process performed in a storage apparatus according to a fourth embodiment of the present invention.

FIG. 14 is a flowchart of another first exemplary specific process showing the decision information extraction from step S1304 and the processing order determination from step S1305 as shown in FIG. 13, according to an aspect of the present embodiment.

FIG. 15 is an exemplary management table which is adapted to manage process details and priority assignment, according to an aspect of the present embodiment.

FIG. 16 is a flowchart of a second exemplary specific process showing decision information extraction from step S1304 and the processing order determination from step S1305 as shown in FIG. 13, according to an aspect of the present embodiment.

FIG. 17 is a sequence diagram showing the synchronization between the completion of an image process and the completion of a writing process, according to an aspect of the present embodiment.

FIG. 18 is a sequence diagram showing the synchronization between the completion of an image process and the completion of a reading process, according to an aspect of the present embodiment.

### DESCRIPTION OF THE EMBODIMENTS

The several embodiments of the present invention will now be described herein below with reference to the drawings.

### First Embodiment

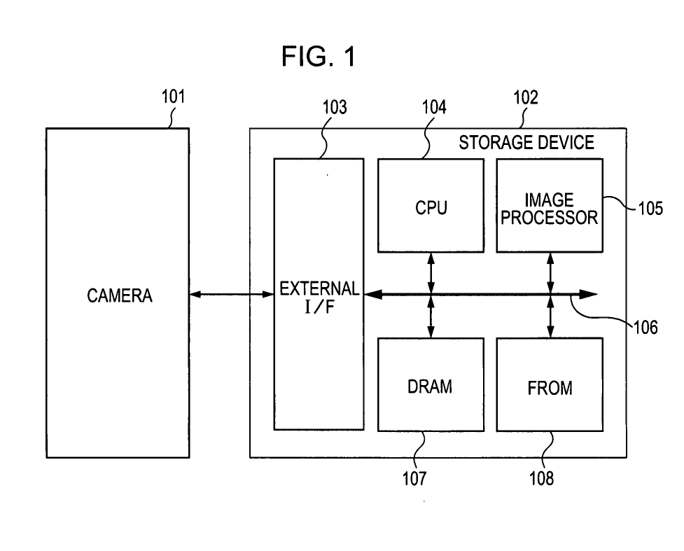

FIG. 1 is a block diagram of an exemplary storage apparatus 102, according to a first embodiment of the present invention. The storage apparatus 102 includes an external interface (I/F) 103, a central processing unit (CPU) 104, an image processor 105, a dynamic random access memory (DRAM) 107, and a flash read-only memory (FROM) 108. The components 103, 104, 105, 107, and 108 are connected via an internal bus 106. The storage apparatus 102 can be connected with a camera 101 or similar image capturing device via the external I/F 103. The CPU 104 is adapted to execute programs stored in the FROM 108 to control the external I/F 103, the image processor 105, and the FROM 108. The FROM 108 is adapted to function as a main memory of the storage apparatus 102. Processes that will be described within the specification and shown in the flowcharts provided in the Figures may be executed and controlled by the CPU 104.

One of the functions of the image processor 105 is to perform requested image processes on image data that is written by the camera 101. The DRAM 107 temporarily stores data necessary for executing the requested image process via one or more programs, the data processed by the image processor 105, and the data written from the camera 101, etc. The FROM 108 stores the programs and the data necessary for executing the programs. The FROM 108 is also written with write data responsive to a write request from the camera 101.

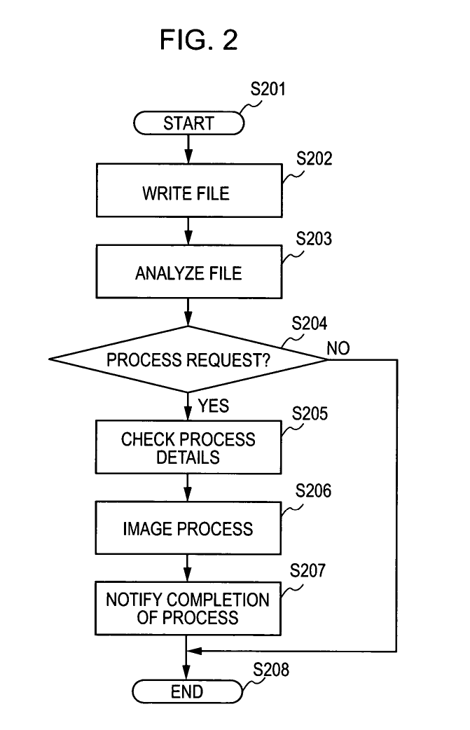

FIG. 2 is a flowchart of an exemplary “basic” process performed in a storage apparatus, according to a first embodiment of the present invention. The basic process is performed when the camera 101 writes image data into the storage apparatus 102. The storage apparatus 102 starts the process upon a write request for image data from the camera 101 (step S201), where data is written to a file (step S202). In response to the writing of the file, the storage apparatus 102 analyzes the file (step S203) and determines whether or not an image process request is present (step S204).

If an image process request is not present, normal writing of data is performed, and the process ends (step S208). If an image process request is present, the process details are checked (step S205), and the requested image process is performed by the image processor 105 (step S206). After performing the image process (step S206), the storage apparatus 102 notifies the camera 101 of the completion of the process (step S207). It is noted that the completion notification in step S207 may be omitted depending on the application or if so desired.

In steps S203 and S204, the file may be analyzed in several different exemplary approaches, including, but not limited to: (1) by examining the file name including the extension, (2) analyzing a text file command, or (3) analyzing tags in the file. The aforementioned exemplary file analysis approaches and process request determinations (hereinafter “specific” processes) are now herein discussed below.

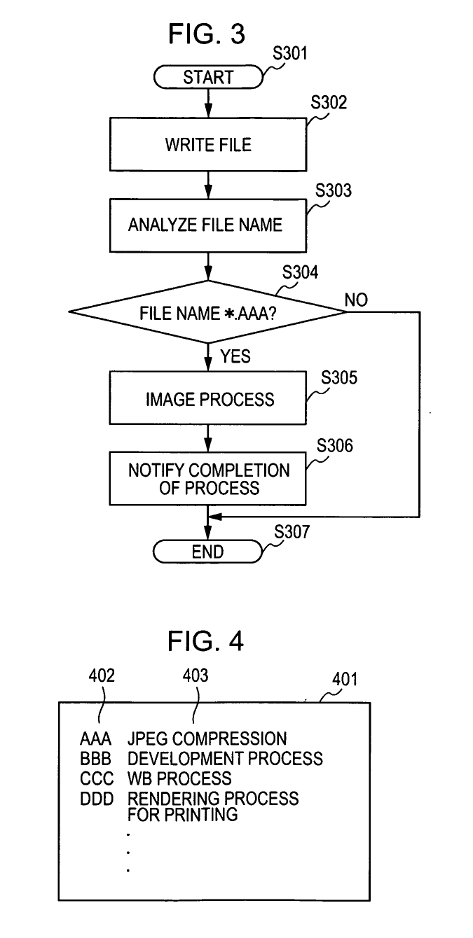

FIG. 3 is a flowchart of a first exemplary specific process showing the file analysis from step S203 and the process request determination from step S204 shown in FIG. 2. Steps S301 and S302 correspond to steps S201 and S202 (from FIG. 2), respectively. In step S303, the file name of the written file is analyzed. In step S304, for example, if the file name includes the extension “.AAA” (one example of image processes shown in FIG. 4), it is determined that an image process request is present; if the file name includes other extensions, it is determined that no request is present. If no request is present, the process ends (step S307). If it is determined that an image process request is present at step S304, then the image process is performed at step S305 by the image processor 105. After performing the image process (step S305), the storage apparatus 102 notifies the camera 101 of the completion of the process (step S306).

FIG. 4 shows an exemplary management table 401 which manages the correspondence between extensions and image processes (special processes). An extension 402 is associated with an image process 403 to be performed when a file having this extension 402 is written. Therefore, the image process request determination in step S304 is based on the management table 401. It is further noted that the management table 401 may be stored on the FROM 108.

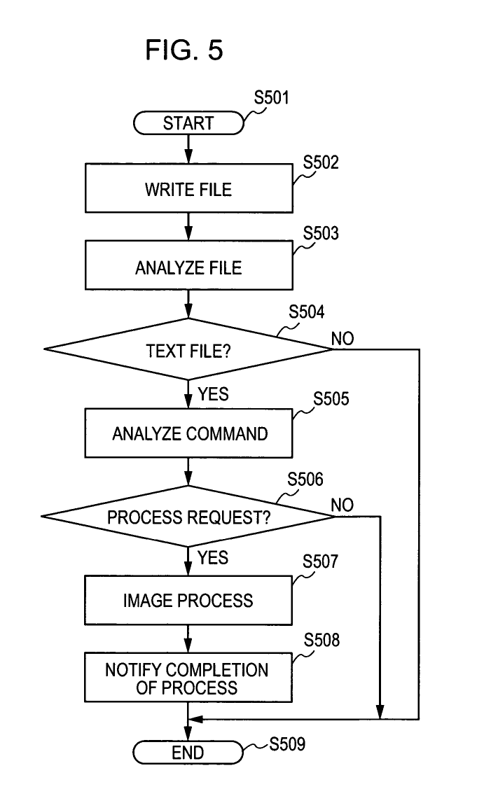

FIG. 5 is a flowchart of a second exemplary specific process showing the file analysis from step S203, the process request determination from step S204, and the process details check from step S205 shown in FIG. 2. Steps S501 and S502 correspond to steps S201 and S202 (from FIG. 2), respectively. The storage apparatus 102 analyzes the written file (step S503), and determines whether or not the file is a text file (step S504). If the file is not a text file, the sequence ends (s509). If the file is a text file, the storage apparatus 102 analyzes the text file (step S505).

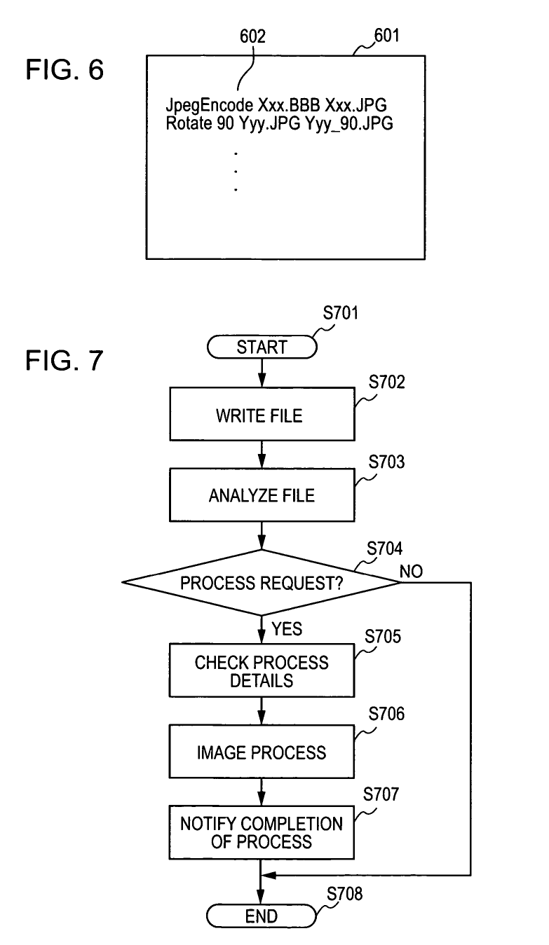

FIG. 6 shows a diagram of an exemplary text file 601 including an image process command. If, for example, a text file 601 includes a command 602 indicating a process request (step S506), the requested image process is performed (step S507). For example, the first line of the command 602 indicates that a file named Xxx.BBB is converted using the JPEG (Joint Photographic Experts Group) compression technique into a file named Xxx.JPG. If the text file includes no commands, the process ends (step S509). After performing the image process (step S507), the storage apparatus 102 notifies the camera 101 of the completion of the process (step S508) and the process ends (step S509).

It is further noted that while the aforementioned process has been described in the context of a text file with a text-based command, by way of example, a binary file with a binary command may also be used.

FIG. 7 is a flowchart of a third exemplary specific process showing the file analysis from step S203 and the process request determination from step S204 shown in FIG. 2. Steps S701 and S702 correspond to steps S201 and S202 (from FIG. 2). Next, the storage apparatus 102 is adapted to analyze a header portion of the written file (step S703). If the header portion includes a process request (step S704), the request written in the header portion is checked (step S705), and the requested image process is performed (step S706).

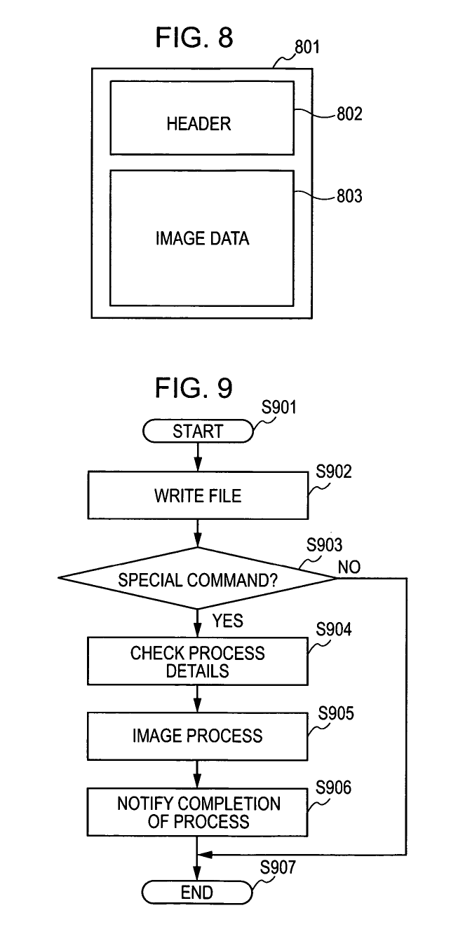

FIG. 8 is a structure diagram of an exemplary image file 801. The image file 801 may include a header portion 802 and an image data portion 803. A process request may also be written in a portion of the header portion 802. After performing the image process (step S706), the storage apparatus 102 notifies the camera 101 of the completion of the process (step S707) and the process ends (step S708).

Thus, when the camera 101 causes the storage apparatus 102 to store uncompressed image data with, for example, the file name Xxx.AAA, the storage apparatus 102 can automatically perform a series and/or variety of process operations, such as converting the image data using the JPEG compression technique and producing a file named Xxx.JPG, in parallel to the process performed by the camera 101.

Therefore, according to the first embodiment of the present invention, a camera causes a storage apparatus 102 to store photographed image data in the storage apparatus 102, thereby allowing the storage apparatus to automatically perform one or more processes on the photographed image data. And as a result, even data to be generated using a conversion method that is not supported by the camera can be generated by the storage apparatus, thereby efficiently generating the data. Furthermore, the camera and the storage apparatus can perform a variety of processes in unison and or in parallel, such as a photographing process and an image process, and a reproduction process and a printing process.

### Second Embodiment

A second embodiment of the present invention will now be described with reference to a first alternative basic process flow which is different from the basic process flow utilized in the first embodiment. It is noted that the system configuration of the second embodiment may be the same as that of the first embodiment, therefore, a description thereof is not necessary, and thus, it has been omitted.

FIG. 9 is a flowchart of the first alternative basic process performed when the camera 101 writes image data into the storage apparatus 102. The storage apparatus 102 starts the process upon a write request for image data (step S901) from the camera 101, wherein image data is written to a file (step S902). In response to the writing of the file, the storage apparatus 102 determines whether or not it has received a special command (step S903).

If a special command has not been received, normal writing of data is performed, and the process ends (step S907). If a special command has been received, the received command is checked (step S904), and the requested image process is performed by the image processor 105 (step S905). After performing the image process in step S905, the storage apparatus 102 notifies the camera 101 of the completion of the process (step S906). It is also noted that the completion notification in step S906 may be omitted depending on the application or if so desired.

Therefore, according to the second embodiment of the present invention, it is only required to transmit a special command from the camera 101 to a storage apparatus 102 to implement the same or similar processes and/or algorithms to those described with respect to and utilized the first embodiment.

### Third Embodiment

A third embodiment of the present invention will now be described with reference to still yet a second alternative basic process flow which is different from that in the first and second embodiments. It is also noted that the system configuration of the third embodiment is the same as that utilized in the first embodiment, and therefore, a description thereof is not necessary and thus it has been omitted.

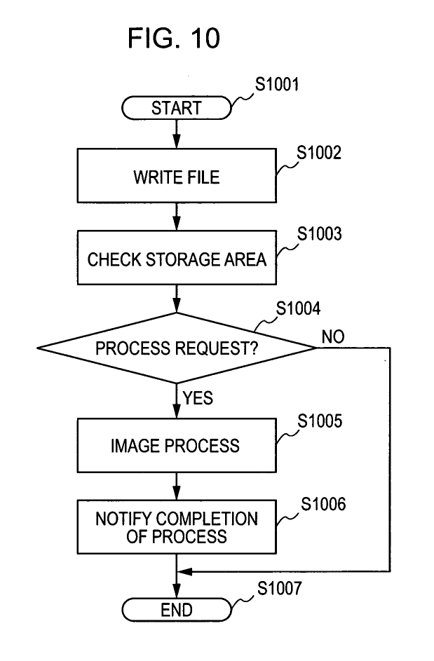

FIG. 10 is a flowchart of the second alternative basic process performed when the camera 101 writes image data into the storage apparatus 102. The storage apparatus 102 starts the process upon a write request for image data (step S1001) from the camera 101, and wherein image data is written with a file in a storage area specified by the camera 101 (step S1002). In response to the writing of the file, first, the storage apparatus 102 checks the storage area in which the image data is written (step S1003), and determines the image process associated with the storage area in which the image data is written (step S1004).

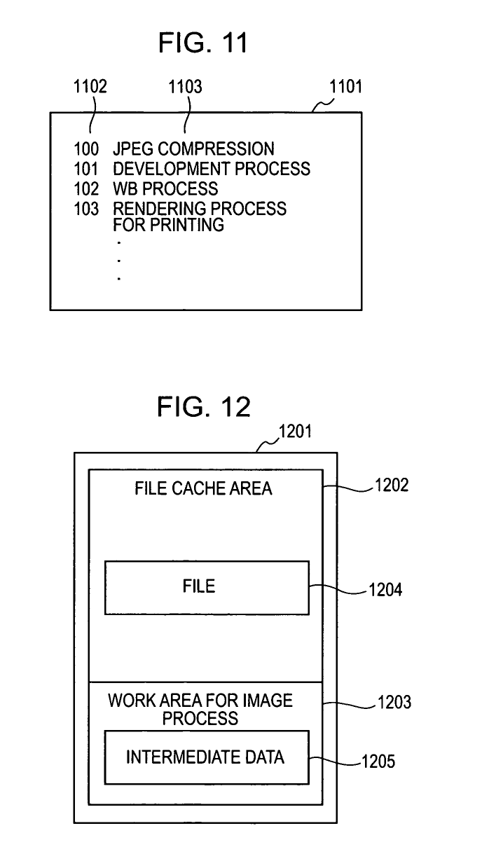

FIG. 11 shows an exemplary management table 1101 which is adapted to manage the correspondence between storage areas and image processes. In the management table 1101, a sector number 1102 indicating a storage area may be associated with an image process 1103 to be performed when a file is written in this sector number 1102. The management table 1101 is stored on the FROM 108.

The image process determination (step S1004) is based on the management table 1101. If there is no image process associated with the storage area, it is determined that normal writing of data is to be performed, and the process ends (step S1007). If the associated image process is found, the requested image process is performed by the image processor 105 (step S1005). After performing the image process, the storage apparatus 102 notifies the camera 101 of the completion of the process (step S1006). It is further noted that the completion notification in step S1006 may be omitted depending on the application.

The storage areas included in the management table 1101 shown in FIG. 11 are areas in which data to be subjected to the image processes is actually written. A write operation into a storage area may correspond to an operation to instruct an image process. In this case, the written data designates a file to be subjected to the image process.

Therefore, according to the third embodiment, it is only required to specify a storage area of data to implement the same or similar processes and/or algorithms to those utilized in the first and second embodiments.

Furthermore, it is noted that exemplary basic process flows described with regard to the first, second, and third embodiments (shown in FIGS. 2, 9, and 10, respectively) may be used independently or in combination.

### Fourth Embodiment

In another aspect of the present embodiment, the above-described process control operations may be performed without using the DRAM 107. Nevertheless, the DRAM 107 provides more rapid processing, and therefore, is found to be a useful component in the present invention. The advantages of utilizing the DRAM 107 will now be described herein below.

FIG. 12 shows an exemplary memory map 1201 of the DRAM 107. The memory map 1201 includes a file cache area 1202 for temporarily storing a written file, and a work area 1203 used for an image process. Pre-allocation of a memory section in the DRAM 107 depends on the application, in which a file 1204 written by the camera 101 or intermediate data 1205 obtained in the image process is stored, allows for rapid writing from the camera 101 and rapid image processing.

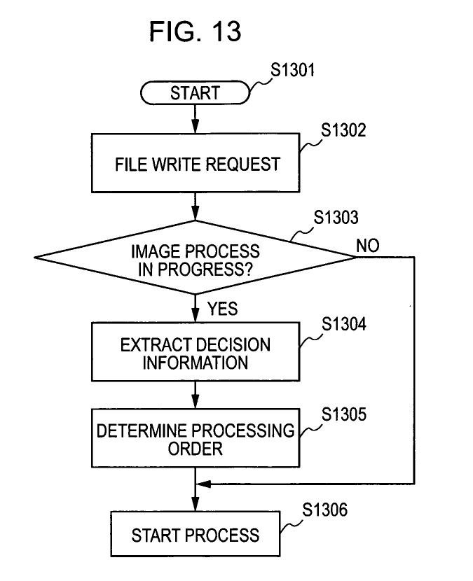

FIG. 13 is a flowchart of still yet a third alternative basic process performed when a file write request or a file read request is received from the camera 101 during an image process. For example, the sequence is initiated (step S1301) and upon a write request from the camera 101 (step S1302), the storage apparatus 102 determines whether or not there is an image process in progress (step S1303).

If there is no image process in progress, the storage apparatus 102 continues the file writing (step S1306). If there is an image process in progress, the storage apparatus 102 extracts information to decide which process has priority to proceed (step S1304). The decision information may include process details, the size of the image data to be processed, and the processing time that is estimated from image data information. Then, the processing order is determined based on the extracted decision information (step S1305). Processing resumes according to the determined processing order (step S1306).

It is further noted that while the aforementioned basic process flows have been described in the context of a write request received from the camera 101, any of the basic flows (including the alternative variants thereof) may also be executed upon a read request.

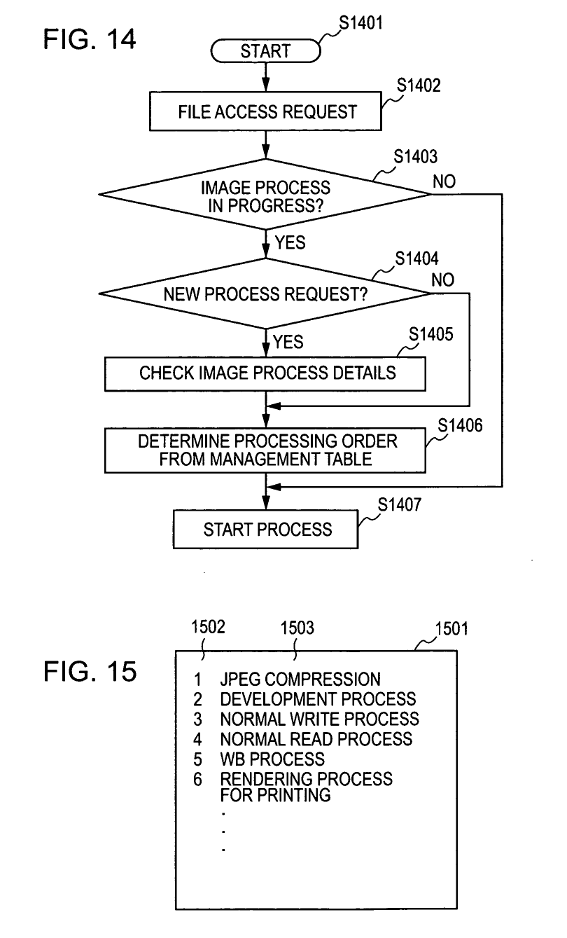

FIG. 14 is a flowchart of another first specific process showing the decision information extraction from step S1304 and the processing order determination from step S1305 shown in FIG. 13. Steps S1401, S1402 and S1403 correspond to steps S1301, S1302 and S1303 (from FIG. 13). Furthermore, the processing of step S1304 in which the information to determine the processing order is extracted corresponds to steps S1404 and S1405, and the processing order determination in step S1305 corresponds to step S1406.

In step S1404, it is determined whether or not a new access request includes a request for a second image process. If the request for the second image process is not present, the processing order is determined (step S1406). If the request for the second image process is present, the details of the second image process are examined (step S1405), and the processing order is then determined (step S1406).

FIG. 15 is an exemplary management table 1501 which is adapted to manage process details and priority assignment In step S1406, the image processing order is determined using a management table 1501 shown in FIG. 15. The exemplary management table 1501 is adapted to manage the correspondence between priorities 1502 and processes 1503. Based on the priorities 1502 in the management table 1501, the processing order of the first image process in progress, the access process involved with the new request, and the second image process responsive to the request is determined.

The processing order is managed using a queue. Each time a new request is received from the camera 101, the processing order is determined, and the process request is added to the queue in this order. The storage apparatus 102 performs the request access process or the image process according to the order on the queue. Once the processing order from the management table is determined (s1406), the process is started (s1407).

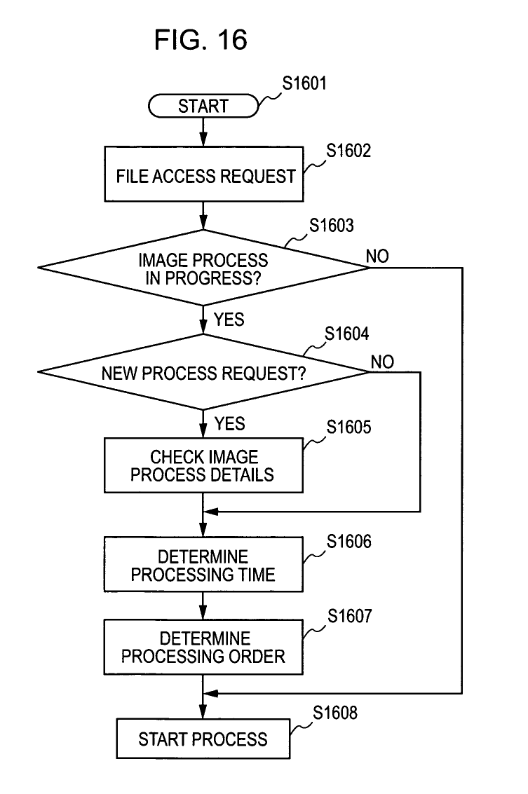

FIG. 16 is a flowchart of another second specific process showing the decision information extraction from step S1304 and the processing order determination from step S1305 shown in FIG. 13. Steps S1601, S1602 and S1603 correspond to steps S1301, S1302 and S1303 (from FIG. 13). Furthermore, the processing of step S1304, in which the information to determine the processing order is extracted, corresponds to steps S1604, S1605, and S1606, and the processing order determination in step S1305 corresponds to step S1607.

In step S1604, it is determined whether or not a new access request includes a request for a second image process. If the request for the second image process is not present, estimations of the second processing time and the first processing time are determined (step S1606), and the processing order is determined from the first processing time and the second processing time (step S1607). If the request for the second image process is present, the details of the second image process are checked (step S1605), and the processing time of the second image process is estimated (step S1606). The first image processing time is also estimated from the details of the first image process in progress (step S1606).

The estimation of each processing time can be determined from the process details, the format of the data to be processed, the data size, etc. The data format and the data size may be obtained using the command received from the camera 101 via the external I/F 103, or may be obtained from header information in the written file. The processing order is determined from the determined estimations of the processing times (step S1607).

The processing order is managed using a queue. Each time a new request is received from the camera 101, the processing order is determined, and the process request is added to the queue in this order. The storage apparatus 102 performs the request access process or the image process according to the order on the queue. Once the processing order is determined (S1607), the process is started (S1608).

It is further noted that according to another aspect of the present embodiment, the various aforementioned processing order determination methods may be used in combination if so desired. As such, by utilizing a combination of the estimations of the processing times and the priority assignments of the processes, it allows for a more efficient determination of the processing order.

### Fifth Embodiment

A fifth embodiment of the present invention provides a method for showing the completion notification in step S207 shown in FIG. 2 with respect to the first embodiment. It is also further noted that the fifth embodiment may be applied to the second and third embodiments previously discussed herein the specification. In step S207, the storage apparatus 102 notifies the camera 101 of the completion of the image process performed in steps S206, and also notifies the camera 101 of an image process result.

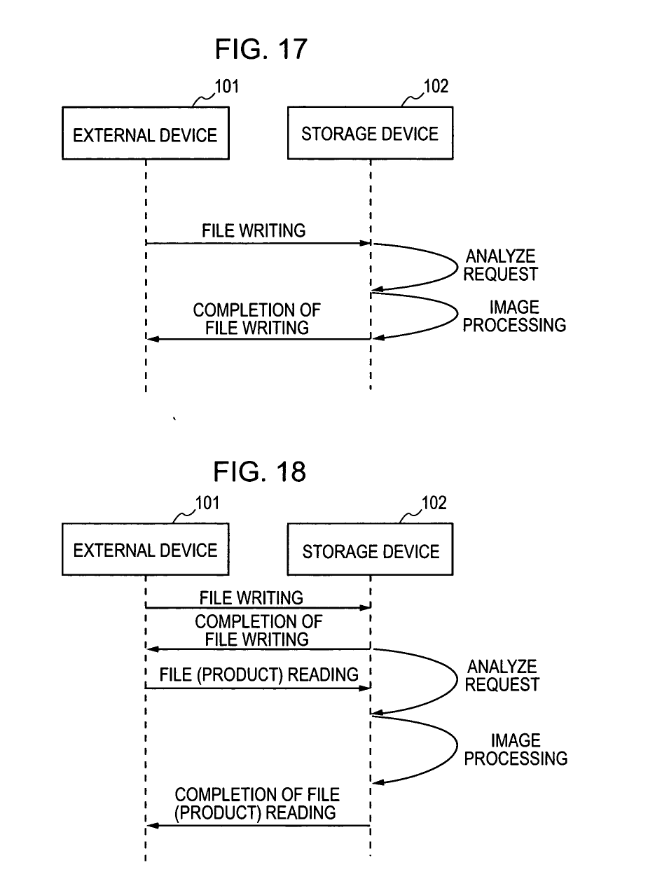

FIG. 17 is a sequence diagram showing the synchronization between the completion of an image process and the completion of a writing process, according to an aspect of the present embodiment. In particular, a first exemplary completion notification process sequence is provided which is an I/F command between the camera 101 and the storage apparatus 102. For example, the camera 101 performs a write operation into the storage apparatus 102, while the storage apparatus 102 performs the series of process steps shown in FIG. 2 and notifies the camera 101 of the completion of the write operation after performing the image process in step S206. Therefore, the camera 101 does not need to take into account whether or not there is an image process in progress.

FIG. 18 is a sequence diagram showing the synchronization between the completion of an image process and the completion of a reading process, according to an aspect of the present embodiment. In particular, a second exemplary completion notification process sequence is provided which is to use a file name after image processing. The file name of the image-processed data is determined according to a predetermined rule so that the image-processed file can be used as a read file. For example, the rule may define that the file name Xxx.RAW before image processing should be the file name Xxx.JPG after image processing.

In the case in which the camera 101 requests the storage device 102 to perform a read operation of such a file, the read operation requested by the camera 101 is in progress while the storage device 102 is performing the image process, and then the read operation requested by the camera 101 is completed when the storage device 102 finishes the image process. In this case, even though such a file has not been prepared in the storage device 102, it is not determined that no file is searched while the image process is in progress. And as a result, the read operation is not completed until the image process finishes. Therefore, the camera 101 does not need to take into account whether or not there is an image process in progress.

Additionally, a third completion notification method is to notify the completion by creating a predetermined file having a designated name on the storage apparatus 102. This file is configured using a predetermined format and command. By utilizing the aforementioned approach for completion notification in step S207, it allows the camera 101 to recognize the completion of the image process performed in step S206 without a special control. Moreover, it is noted that the first and second methods also allow the camera 101 to consistently accomplish processes without being aware of any special control or the image process itself.

### Other Exemplary Embodiments

In the foregoing embodiments, special processes and or algorithms which may include, but are not limited to, compression, rotation, rendering, white balance (WB) processing, and development. Furthermore, other processes and/or algorithms enabled by cameras, such as object recognition, color conversion, resolution conversion, image synthesis, and optical character recognition (OCR), may also be used.

The storage apparatus disclosed in the foregoing embodiments may be an apparatus having any data storage function, such as a PC, a printer, or a display, or a multifunctional apparatus. It is further noted and acknowledged that a data transmitting apparatus is not limited to a camera, and may be any other apparatus, such as a camera-equipped portable telephone or a scanner. Furthermore, the communication means and the transmission medium between the external interface and the camera should not be specifically limited by the aforementioned specification; rather they may be comprised of, for sake of example, a USB (universal serial bus) cable, a wireless local area network (LAN), or any other data transmission means known in the art.

The present invention may also be implemented by supplying a storage medium for storing program code of software implementing a feature of the foregoing embodiments to a system or an apparatus and by causing a computer [or a CPU or an MPU (micro-processing unit)] of the system or apparatus to read and execute the program code stored in the storage medium. In this case, the program code read from the storage medium may implement a feature of the foregoing embodiments, and the storage medium in which the program code is stored may constitute an aspect of any one of the plurality of embodiments of the present invention.

It is further noted that storage media for providing program code may include, but is not limited to, a floppy disk, a hard disk, an optical disk, a magneto-optical disk, a compact disc read-only memory (CD-ROM), a digital versatile disc read-only memory (DVD-ROM), a magnetic tape, a non-volatile memory card, a ROM, or any other data storage media known in the art.

Furthermore, an aspect or feature of the foregoing embodiments may be implemented by executing program code read by the computer. In addition, an operating system (OS) or the like, running on the computer may perform a portion of actual processing according to the instruction of the program code, thereby implementing a feature or aspect of the foregoing embodiments.

Additionally, the program code read from the storage medium may be written into a memory of a function extension board inserted into the computer or a function extension unit connected to the computer, and a CPU or the like provided for the function extension board. And yet still further, the function extension unit may then perform a portion or the entirety of the actual processing according to the instruction of the program code, thereby, implementing a feature of the foregoing embodiments.

While the present invention has been described in the context of preferred embodiments, it is acknowledged that the present invention is not limited to the foregoing embodiments, and a variety of modifications may be made without departing from the scope of the present invention.

While the present invention has been described with reference to exemplary embodiments, it is to be understood that the invention is not limited to the disclosed exemplary embodiments. Rather, the scope of the following claims is to be accorded the broadest interpretation so as to encompass all modifications, equivalent structures and functions.

This application claims the benefit of Japanese Application No. 2004-287650 filed Sep. 30, 2004, which is hereby incorporated by reference herein in its entirety.

What is claimed is:

1. A data storage apparatus comprising:
a storage device adapted to store and read digital data;
an external connection device adapted to communicate with an external apparatus;
a control device adapted to respond to writing of data input from the external connection device into the storage device and adapted to analyze written data; and
a processing device adapted to perform a process on the written data according to an analysis performed by the control device.

2. The apparatus according to claim 1, wherein the control device determines the process performed by the processing device based on a file name of the written data, the file name including an extension.

3. The apparatus according to claim 1, wherein the control device interprets a command included in a written text file, and determines the process performed by the processing device based on the interpreted command.

4. The apparatus according to claim 1, wherein the control device interprets a command included in a tag portion of a written file, and determines the process performed by the processing device based on the interpreted command.

5. The apparatus according to claim 1, wherein the control device notifies completion of the process by using a control command in the external connection device.

6. The apparatus according to claim 5, wherein the control device notifies a result of the process by using a control command in the external connection device.

7. The apparatus according to claim 5, wherein the control device notifies completion of the special process by creating a predetermined file.

8. The apparatus according to claim 7, wherein the control device notifies a result of the process by creating a file according to a predetermined format or command.

9. The apparatus according to claim 5, wherein the control device is adapted to respond to a request from the external apparatus to transfer the data subjected to the process as a read file to the external apparatus.

10. The apparatus according to claim 9, wherein when a file specified in a read request sent from the external apparatus is not present and when a process request has been received and a file subjected to the special process is present, the control device receives the read request, and transfers the file subjected to the process as the read file when the process is completed.

11. A data storage apparatus comprising:
a storage device adapted to store and read digital data;
an external connection device adapted to communicate with an external apparatus;
a control device adapted to respond to writing of data input from the external connection device into the storage device and adapted to interpret a control command that is input from the external connection device; and
a processing device adapted to perform a process on the written data according to the control command interpreted by the control device.

12. A data storage apparatus comprising:
a storage device adapted to store and read digital data;
an external connection device adapted to communicate with an external apparatus;
a control device adapted to respond to writing of data input from the external connection device into the storage device and adapted to determine whether or not the written data is stored in a predetermined storage area; and
a processing device adapted to perform a process on the written data according to a determination result of the control device.

13. A data storage apparatus comprising:
a first storage device adapted to store and read digital data;
an external connection device adapted to communicate with an external apparatus;
a control device adapted to respond to writing of data input from the external connection device into the first storage device and adapted to analyze the data written from the external apparatus;
a processing device adapted to perform a process on the written data according to an analysis performed by the control device; and
a second storage device adapted to store a program for controlling the control device and data processed by the processing device.

14. The apparatus according to claim 13, wherein the control device is adapted to perform a control operation so that the second storage device serves as a storage device for temporarily storing a file written from the external apparatus.

15. A data storage apparatus comprising:
a storage device adapted to store and read digital data;
an external connection device adapted to communicate with an external apparatus;
a control device adapted to respond to writing of data input from the external connection device into the first storage device and adapted to analyze the data written from the external apparatus; and
a processing device adapted to perform at least one process on the written data according to an analysis performed by the control device,
wherein the control device is adapted to respond to a second request from the external apparatus while a first process is performed responsive to a first request to interpret the second request, and determines priorities of the processes responsive to the first request and the second request.

16. The apparatus according to claim 15, wherein the control device determines a processing order by comparing the first request from the external apparatus with the second request from the external apparatus.

17. The apparatus according to claim 16, wherein the control device determines a processing order from a predicted remaining processing time of the process responsive to the first request from the external apparatus and a predicted processing time of the process responsive to the second request.

18. The apparatus according to claim 17, wherein the control device predicts processing time from the size of the data to be subjected to the at least one process.

19. The apparatus according to claim 17, wherein the control device predicts a processing time from tag information affiliated with the data to be subjected to the at least one process.

20. A data processing method for a data storage apparatus including a storage device for storing and reading digital data and an external connection device for communicating with an external apparatus, the method comprising:
responding to writing of data input from the external connection device into the storage device to analyze the written data; and
performing a process on the written data according to the analysis performed on the written data.

21. A data processing method for a data storage apparatus including a storage device for storing and reading digital data and an external connection device for communicating with an external apparatus, the method comprising:
responding to writing of data input from the external connection device into the storage device to interpret a control command that is input from the external connection device; and
performing a process on the written data according to the interpreted control command.

22. A data processing method for a data storage apparatus including a storage device for storing and reading digital data and an external connection device for communicating with an external apparatus, the method comprising:
responding to writing of data input from the external connection device into the storage device to determine whether or not the written data is stored in a predetermined storage area; and
a special processing step of performing a special process on the written data according to a determination result with regard to whether or not the written data is stored in a predetermined storage area.

23. A data processing method for a data storage apparatus including a storage device for storing and reading digital data and an external connection device for communicating with an external apparatus, the method comprising:
responding to writing of data input from the external connection device into the storage device to analyze the data written from the external apparatus;
performing a process on the written data according to an analysis with regard to the written data; and
providing a second storage device for storing a program for controlling the analysis and the processed data.

24. A data processing method for a data storage apparatus including a storage device for storing and reading digital data and an external connection device for communicating with an external apparatus, the method comprising:
responding to writing of data input from the external connection device into the storage device to analyze the data written from the external apparatus; and
performing a process on the written data according to an analysis with regard to the written data,
wherein the analysis responds to a second request from the external apparatus during the process responsive to a first request to interpret the second request, and determines priorities of the process responsive to the first request and the second request.
